(19) United States
(12) Patent Application Publication
(10) Pub. No.: US 2025/0348038 A1
(43) Pub. Date: Nov. 13, 2025

(54) IMAGE FORMING APPARATUS

(71) Applicant: CANON KABUSHIKI KAISHA, Tokyo (JP)

(72) Inventor: KOTARO TORIKATA, Chiba (JP)

(21) Appl. No.: 19/194,121

(22) Filed: Apr. 30, 2025

(30) Foreign Application Priority Data
May 10, 2024 (JP) 2024-077478

(51) Int. Cl. G03G 15/00; H04N 1/00

(52) U.S. Cl. CPC G03G 15/80; H04N 1/00885

(57) ABSTRACT

The image forming apparatus includes a casing including a pillar portion extending in a vertical direction, a circuit board, a board supporting member configured to support the circuit board, a base fixed to the pillar portion, a handle portion supported by the base, and, a linking member formed of a bent plate member and configured to link the pillar portion and the board supporting member. The linking member includes a first fixed-plate portion fixed to the pillar portion, a second fixed-plate portion to which the board supporting member is fixed, a first bent portion formed at an edge portion of the first fixed-plate portion, a second bent portion formed at an edge portion of the second fixed-plate portion, and at least one intermediate plate portion configured to connect the first bent portion and the second bent portion continuously.

### BACKGROUND OF THE INVENTION

### Field of the Invention

The present invention relates to image forming apparatuses such as copying machines, printers, facsimiles, and multifunction printers having a plurality of functions of these products.

### Description of the Related Art

An image forming apparatus includes a handle portion for lifting the apparatus when the apparatus is installed or carried. For example, the handle portion is used for lifting the apparatus in work for lowering the apparatus from a packing material when the apparatus is installed, or for lifting the apparatus for moving the apparatus over a step or the like in a building when the apparatus is carried in the building. As such a handle portion, Japanese Patent Application Publication Nos. 2011-252986 and 2006-209049 propose a pivotable handle portion that is suitably held with hands in a case where the apparatus has a heavy weight.

In a configuration described in Japanese Patent Application Publication No. 2011-252986, a handle-stay load receiving portion is disposed so as to be orthogonal to a handle portion that has been pivoted to a horizontal position for lifting an image forming apparatus. The configuration described in Japanese Patent Application Publication No. 2011-252986 includes a backup portion for supporting the handle-stay load receiving portion. The backup portion is disposed for suppressing the deformation of the handle-stay load receiving portion because the handle-stay load receiving portion may deform if the handle portion that has been pivoted is pressed upward.

In a configuration described in Japanese Patent Application Publication No. 2006-209049, a side plate that constitutes an image forming apparatus is attached with a reinforcing bracket made of a high-tensile steel plate or the like that has higher strength than that of the side plate. In this configuration, the reinforcing bracket and the side plate support a pivot shaft, and the pivot shaft holds a handle portion. Thus, the handle portion can be firmly held by the pivot shaft.

By the way, it is considered that the handle portion can be fixed to a pillar portion of a casing that constitutes an image forming apparatus. On the other hand, there is a case where a circuit board, such as a control board for controlling the image forming apparatus, is supported by the pillar portion of the casing, via a board supporting member such as a supporting metal plate. If the circuit board can be disposed in the vicinity of the pillar portion, the flexibility in layout of the circuit board increases, and the apparatus can be made compact. However, it is not preferable that the external force is exerted on the circuit board, because electric elements are mounted on the circuit board. In a case where the handle portion is disposed on the pillar portion as described above and the circuit board is disposed in the vicinity of the pillar portion, the external force may be exerted on the circuit board via the pillar portion and the board supporting member when the image forming apparatus is lifted by using the handle portion.

The configuration described in each of Japanese Patent Application Publication Nos. 2011-252986 and 2006-209049 is intended to suppress the deformation of members of the handle portion caused by the force for lifting the handle portion. Thus, even if the handle portion described in each of Japanese Patent Application Publication Nos. 2011-252986 and 2006-209049 is fixed to the pillar portion, it is not possible to suppress the external force from being exerted on the circuit board.

### SUMMARY OF THE INVENTION

The present invention provides a configuration that can suppress the external force from being exerted on the circuit board even if the handle portion is fixed to the pillar portion, in the vicinity of which the circuit board is disposed.

According to one aspect of the present invention, an image forming apparatus configured to form an image on a recording material. The image forming apparatus includes a casing including a pillar portion extending in a vertical direction, a circuit board, a board supporting member configured to support the circuit board, a base fixed to the pillar portion, a handle portion supported by the base, and, a linking member formed of a bent plate member and configured to link the pillar portion and the board supporting member. The linking member includes a first fixed-plate portion fixed to the pillar portion, a second fixed-plate portion to which the board supporting member is fixed, a first bent portion formed at an edge portion of the first fixed-plate portion, a second bent portion formed at an edge portion of the second fixed-plate portion, and at least one intermediate plate portion configured to connect the first bent portion and the second bent portion continuously. Each of the first bent portion and the second bent portion is bent such that an edge line extends along the vertical direction.

Further features of the present invention will become apparent from the following description of exemplary embodiments with reference to the attached drawings.

### BRIEF DESCRIPTION OF THE DRAWINGS

FIG. 1 is a perspective view of an image forming apparatus of an embodiment.

FIG. 2A is a perspective view of a handle portion that is in a storage position, and surroundings of the handle portion of the embodiment.

FIG. 2B is a perspective view of the handle portion that is in a use position, and the surroundings of the handle portion of the embodiment.

FIG. 3 is a perspective view of the handle portion, a linking member, and surroundings of the handle portion and the linking member of the embodiment, viewed from a pillar portion side.

FIG. 4 is a perspective view of the handle portion, the linking member, and the surroundings of the handle portion and the linking member of the embodiment, viewed from a circuit board side.

FIG. 5 is a plan view of the handle portion, the linking member, and the surroundings of the handle portion and the linking member of the embodiment.

FIG. 6 is a perspective view of the linking member of the embodiment.

### DESCRIPTION OF THE EMBODIMENTS

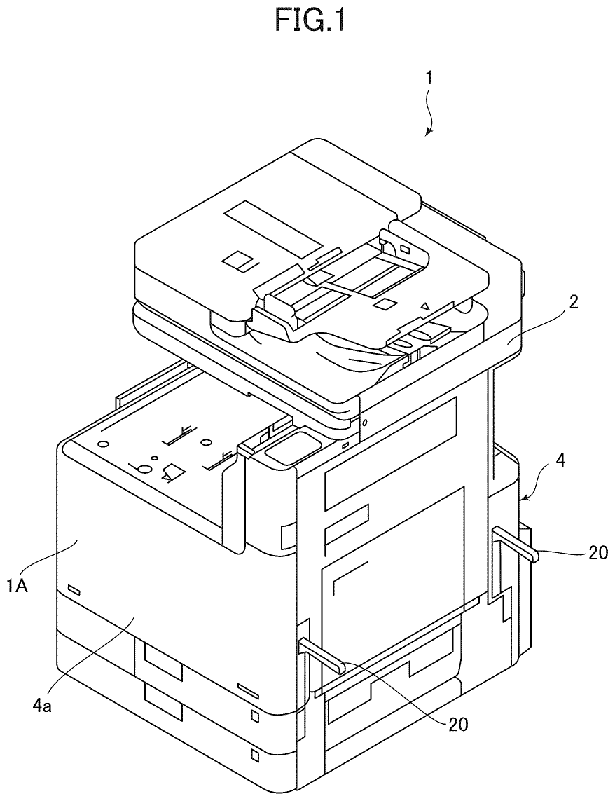

Next, an embodiment will be described with reference to FIGS. 1 to 6. FIG. 1 is a perspective view of an image forming apparatus 1 of the present embodiment. For example, the image forming apparatus 1 is an electrophotographic full-color printer that includes four image forming portions that correspond to four colors of yellow, magenta, cyan, and black. The image forming apparatus 1 forms a toner image (image) on a recording material in accordance with an image signal sent from an image reading unit (document reading apparatus) 2 connected to an image forming apparatus body 1A, or from a host device, such as a personal computer, communicatively connected to the image forming apparatus body 1A. The recording material may be a sheet material, such as a paper sheet, a plastic film, or a cloth sheet.

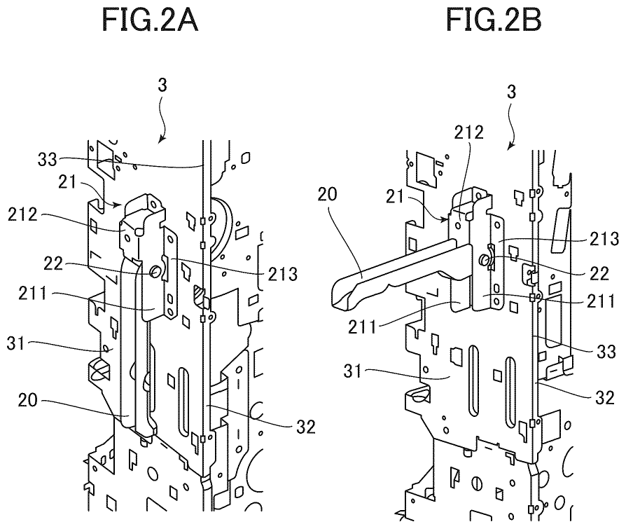

The image forming apparatus 1 includes a casing 4 that accommodates the above-described image forming portions. The casing 4 includes a frame and an outer cover 4a. The frame is constituted by a plurality of pillar portions 3 (for example, see FIGS. 2A and 2B) and side plates. In addition, the image forming apparatus 1 of the present embodiment includes a handle portion 20 that can be held with hands when the image forming apparatus 1 is lifted when carried, for example. The handle portion 20 is disposed in a side surface of the image forming apparatus 1. For example, in a case where the side on which an operation portion for operating the image forming apparatus 1 is disposed is referred to as a front side, and where the side opposite to the front side is referred to as a back side (or a back surface side), the handle portion 20 is disposed in any one of side surfaces in the right and left direction viewed from the front side, or in both of the side surfaces. Note that the handle portion 20 may be disposed in one of a side surface of the image forming apparatus 1 on the front side and a side surface of the image forming apparatus 1 on the back side, or may be disposed in both of the side surfaces. In addition, the handle portion 20 is a pivotable handle portion that pivots upward from a storage position. Thus, the handle portion 20 is drawn out of the casing 4 by pivoting the handle portion 20 upward from the storage position.

### Configuration of Handle Portion and its Surroundings

Each of FIGS. 2A and 2B is a perspective view illustrating the handle portion 20 disposed on a pillar portion 3 of the casing 4, and its surroundings. In each of FIGS. 2A and 2B, a below-described linking member 5 is not illustrated. In the present embodiment, the handle portion 20 is disposed on a side surface of the pillar portion 3 of the casing 4. Specifically, a handle support stand 21 that serves as a base is fixed to the pillar portion 3, and the handle portion 20 is pivotably supported by the handle support stand 21 via a pivot shaft 22. The pivot shaft 22 is disposed so that an axial direction (that is a substantially horizontal direction in the present embodiment) intersects a vertical direction (i.e., the vertical direction in a state where the image forming apparatus 1 is installed). The pivot shaft 22 supports a base end portion of the handle portion 20 such that the handle portion 20 can pivot with respect to the handle support stand 21.

Thus, the handle portion 20 can pivot between the storage position (illustrated in FIG. 2A) which serves as a first position, and a use position (illustrated in FIG. 2B) which serves as a second position around the pivot shaft 22. In the second position, a tip portion of the handle portion 20 is separated more from the pillar portion 3 than the tip portion of the handle portion 20 positioned in the first position is. That is, FIG. 2A illustrates a posture of the handle portion 20 that is not pivoted upward. In other words, FIG. 2A illustrates a posture of the handle portion 20 that is in a storage state where the handle portion 20 is not drawn out of the casing 4. In addition, FIG. 2B illustrates a posture of the handle portion 20 that has been pivoted upward. In other words, FIG. 2B illustrates a posture of the handle portion 20 that is in lifting work where the handle portion 20 is drawn out of the casing 4.

For example, the handle portion 20 is formed by performing bending work on a plate member (i.e., a metal plate) made of metal. The handle portion 20 has an elongated shape that extends in the longitudinal direction, and the base end portion (i.e., an upper end portion in FIG. 2A) of the handle portion 20 in the longitudinal direction is pivotally supported by the handle support stand 21 via the pivot shaft 22 such that the handle portion 20 can pivot. For example, the handle support stand 21 is formed by performing bending work on a plate member made of metal. The handle support stand 21 includes a pair of supporting plate portions 211 arranged parallel to each other, a connecting plate portion 212, and an attaching plate portion 213. The connecting plate portion 212 connects the pair of supporting plate portions 211 to each other.

The pivot shaft 22 is supported by the pair of supporting plate portions 211. The base end portion of the handle portion 20 is disposed between the pair of supporting plate portions 211 in a state where the base end portion of the handle portion 20 is supported by the pivot shaft 22. As illustrated in FIG. 2A, the distance between the pair of supporting plate portions 211 is set so that one portion of the handle portion 20 in the longitudinal direction that includes the base end portion can enter the space between the pair of supporting plate portions 211 even if the handle portion 20 is in the storage position. The connecting plate portion 212 connects the pair of supporting plate portions 211 to each other at a position above the pivot shaft 22 and the base end portion of the handle portion 20. The connecting plate portion 212 serves as a regulation portion. As illustrated in FIG. 2B, in a state where the handle portion 20 is in the use position, the connecting plate portion 212 prevent the handle portion 20 from further pivoting toward a pivot direction (i.e., a direction in which the tip portion of the handle portion 20 moves upward) in which the handle portion 20 pivots on the pivot shaft 22 from the storage position toward the use position. That is, in the use position, the base end portion of the handle portion 20 is abutted against the connecting plate portion 212, so that the handle portion 20 is prevented from further pivoting. In this state, the image forming apparatus 1 can be lifted by using the handle portion 20.

The pillar portion 3 constitutes one portion of the frame of the casing 4, and is disposed such that the longitudinal direction of the pillar portion 3 is equal to the vertical direction. That is, the casing 4 includes the pillar portion 3 that extends in the vertical direction. The pillar portion 3 is formed by bending a plate member made of metal, and includes a first plate portion 31, a second plate portion 32, and a pillar-side bent portion 33. The first plate portion 31 is a side-plate portion of the pillar portion 3, to which the handle support stand 21 is fixed. The second plate portion 32 is a plate portion formed so as to extend in a direction that extends from the first plate portion 31 toward a below-described circuit board 62. The pillar-side bent portion 33 is a bent portion that is bent such that the pillar-side bent portion 33 connects the first plate portion 31 and the second plate portion 32 continuously, and that the edge line of the pillar-side bent portion 33 extends along the vertical direction.

### Relationship Between Circuit Board and Handle Portion

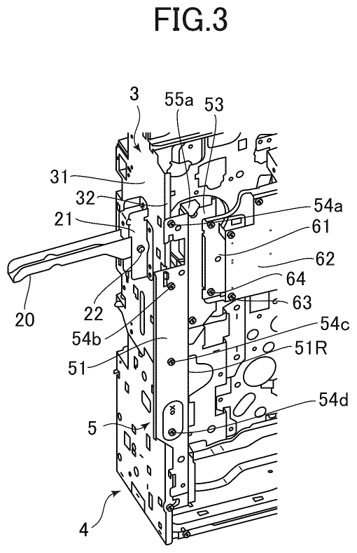

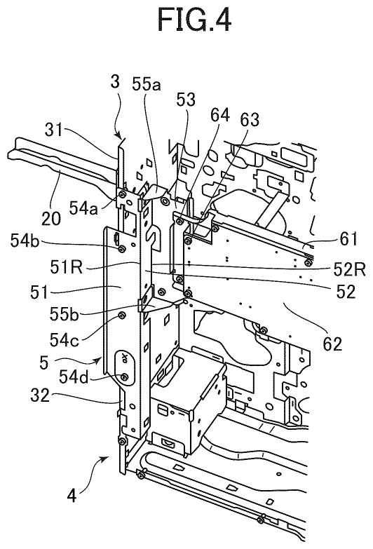

Next, the relationship between the above-described handle portion 20 and the circuit board 62 will be described with reference to FIGS. 3 and 4. In the present embodiment, as illustrated in FIGS. 3 and 4, in the vicinity of the pillar portion 3 on which the handle portion 20 is disposed, the circuit board 62 and a board supporting member 61 that supports the circuit board 62 are disposed. For example, the circuit board 62 is a control board that is disposed on the back surface side of the casing 4 and that controls the image forming apparatus 1, or a power supply board for a heater or a motor disposed in the image forming apparatus 1. On the circuit board 62, electric elements are mounted. Thus, it is preferable that the external force not be exerted on solder portions and the like of the electric elements mounted on the circuit board 62.

However, it is necessary that the electrical contact between the circuit board 62 and the board supporting member 61 made of metal be kept for suppressing the occurrence of noise. For this reason, the circuit board 62 is fastened to the board supporting member 61 via, for example, a screw 63 that is a fastening member made of metal. Thus, if the external force is exerted on the board supporting member 61 that supports the circuit board 62, the external force may also be exerted on the circuit board 62 via a fastening member such as the screw 63. For preventing the external force from being exerted on the circuit board 62, it is preferable that the external force not be exerted on the board supporting member 61 that supports the circuit board 62.

By the way, if the circuit board 62 can be placed in the vicinity of the pillar portion 3 on which the handle portion 20 is disposed, the flexibility in layout of the circuit board 62 increases, and the apparatus can be made compact. That is, the space in the apparatus can be used effectively. For achieving this, it can be conceived that the board supporting member 61 that supports the circuit board 62 is fixed to the second plate portion 32 adjacent to the first plate portion 31 of the pillar portion 3 on which the handle portion 20 is disposed. However, if the image forming apparatus 1 is lifted in a state where the handle portion 20 is held, the force exerted from the handle portion 20 is exerted on the pillar portion 3 on which the handle portion 20 is disposed. Thus, if the board supporting member 61 is disposed on the second plate portion 32, the force exerted from the handle portion 20 may be exerted on the board supporting member 61 via the pillar portion 3.

Thus, in the present embodiment, for suppressing the force exerted from the handle portion 20 from being exerted on the board supporting member 61 via the pillar portion 3, the linking member 5 is disposed between the pillar portion 3, to which the handle portion 20 is fixed, and the board supporting member 61, which supports the circuit board 62.

### Linking Member

Next, the linking member 5 of the present embodiment will be described with reference to FIGS. 3 to 6. As illustrated in FIGS. 3 and 4, the linking member 5 is a member that links the pillar portion 3, to which the handle portion 20 is fixed, and the board supporting member 61, which supports the circuit board 62. In the present embodiment, the circuit board 62 is disposed on the back surface side of the image forming apparatus 1. Thus, in the example illustrated in the figures, the pillar portion 3 to which the handle portion 20 is fixed is positioned on the back surface side of the casing 4, and on the left side (i.e., the right side viewed from the front side) viewed from the back surface side. In addition, the linking member 5 links a left edge portion of the board supporting member 61 viewed from the back surface side and the pillar portion 3. Note that like the left edge portion of the board supporting member 61, a right edge portion of the board supporting member 61 viewed from the back surface side may be supported by a pillar portion on the right side viewed from the back surface side, via a linking member 5. In another case, the right edge portion of the board supporting member 61 viewed from the back surface side may be supported by another member that constitutes the frame of the casing 4.

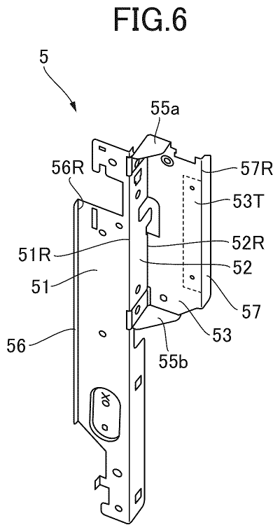

The linking member 5 is formed by bending a plate member (i.e., a metal plate) made of metal. In other words, the linking member 5 is formed of the bent plate member. As illustrated in FIG. 6, the linking member 5 includes a first fixed-plate portion 51, a second fixed-plate portion 53, a first bent portion 51R, a second bent portion 52R, and at least one intermediate plate portion 52. The first bent portion 51R and the second bent portion 52R serve as a plurality of bent portions. In the present embodiment, the intermediate plate portion 52 is one in number.

The first fixed-plate portion 51 is fixed to the pillar portion 3. The second fixed-plate portion 53 is a portion to which the board supporting member 61 is fixed. The first bent portion 51R is formed at an edge portion of the first fixed-plate portion 51. The second bent portion 52R is formed at an edge portion of the second fixed-plate portion 53. The intermediate plate portion 52 (i.e., a first intermediate plate portion) connects the first bent portion 51R and the second bent portion 52R continuously. In other words, the first bent portion 51R connects the first fixed-plate portion 51 and the intermediate plate portion 52 continuously. The second bent portion 52R connects the intermediate plate portion 52 and the second fixed-plate portion 53 continuously. Each of the first bent portion 51R and the second bent portion 52R is bent such that an edge line extends along the vertical direction.

The first fixed-plate portion 51 is formed so as to extend in the vertical direction, parallel to the second plate portion 32 of the pillar portion 3 on which the handle portion 20 is disposed. In addition, the first fixed-plate portion 51 is in contact with the second plate portion 32, and is fastened to the second plate portion 32 via screws 54a to 54d that serve as a fastening member.

The intermediate plate portion 52 is formed so as to extend in a direction orthogonal to the first fixed-plate portion 51, and is continuous with the first fixed-plate portion 51 via the first bent portion 51R. The direction in which the intermediate plate portion 52 is formed so as to extend is a direction that extends inward of the casing 4 (that is, toward the front side in the present embodiment) with respect to the first fixed-plate portion 51.

The first bent portion 51R is a portion bent at a substantially right angle from an edge portion of the first fixed-plate portion 51 on the inner side in a width direction of the first fixed-plate portion 51 orthogonal to the vertical direction (the edge portion of the first fixed-plate portion 51 is, in the present embodiment, an edge portion of the first fixed-plate portion 51 on the right side viewed from the back surface side). The first bent portion 51R is continuous with an edge portion of the intermediate plate portion 52 on the outer side in a width direction of the intermediate plate portion 52 orthogonal to the vertical direction (the edge portion of the intermediate plate portion 52 is, in the present embodiment, an edge portion of the intermediate plate portion 52 on the back surface side). The edge line of the first bent portion 51R is a line that extends along the vertical direction.

The second fixed-plate portion 53 is formed so as to extend in a direction orthogonal to the intermediate plate portion 52, and is continuous with the intermediate plate portion 52 via the second bent portion 52R The direction in which the second fixed-plate portion 53 is formed so as to extend is opposite to the direction in which the first fixed-plate portion 51 is formed so as to extend, with respect to the intermediate plate portion 52. That is, the direction in which the second fixed-plate portion 53 is formed so as to extend is a direction that extends toward the board supporting member 61 side (the direction extends, in the present embodiment, toward the right side viewed from the back surface side).

The second bent portion 52R is a portion bent at a substantially right angle from an edge portion of the intermediate plate portion 52 on the inner side in a width direction of the intermediate plate portion 52 orthogonal to the vertical direction (the edge portion of the intermediate plate portion 52 is, in the present embodiment, an edge portion of the intermediate plate portion 52 on the front side). The second bent portion 52R is continuous with an edge portion of the second fixed-plate portion 53 on a side opposite to the board supporting member 61 in a width direction of the second fixed-plate portion 53 orthogonal to the vertical direction. The edge line of the second bent portion 52R is a line that extends along the vertical direction.

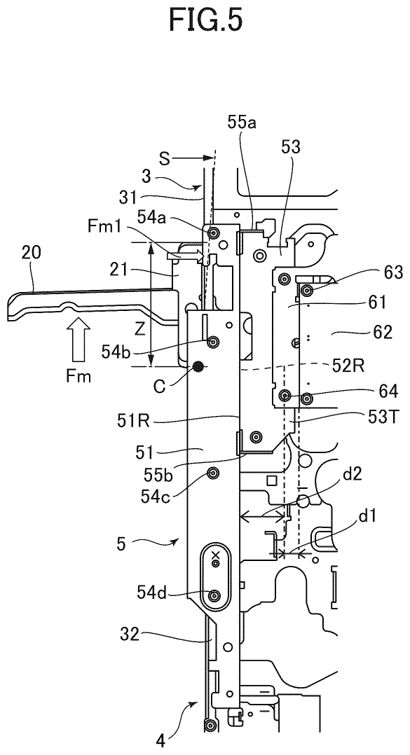

The board supporting member 61 is fastened to the second fixed-plate portion 53 via a screw 64 that serves as a board-side fastening member, at a predetermined fastening position 53T (see FIG. 6). As illustrated in FIG. 5, the predetermined fastening position 53T at which the board supporting member 61 is fastened is a position separated from the second bent portion 52R. That is, a distance d1 between the predetermined fastening position 53T (i.e., the position at which the board supporting member 61 is fastened via the screw 64) and an edge portion of the second fixed-plate portion 53 opposite to the second bent portion 52R (the edge portion of the second fixed-plate portion 53 is an edge portion of the second fixed-plate portion 53 on the right side in FIG. 5) is shorter than a distance d2 between the predetermined fastening position 53T and the second bent portion 52R.

In addition, in the present embodiment, each of the first fixed-plate portion 51, the second fixed-plate portion 53, the first and second bent portions 51R and 52R, and the intermediate plate portion 52 is formed so as to be continuous in the vertical direction such that the upper end of each of the first fixed-plate portion 51, the second fixed-plate portion 53, the first and second bent portions 51R and 52R, and the intermediate plate portion 52 is positioned above the upper end of the handle support stand 21, and that the lower end of each of the first fixed-plate portion 51, the second fixed-plate portion 53, the first and second bent portions 51R and 52R, and the intermediate plate portion 52 is positioned below the lower end of the handle support stand 21. That is, the length of each portion of the linking member 5 (i.e., each of the first fixed-plate portion 51, the second fixed-plate portion 53, the first and second bent portions 51R and 52R, and the intermediate plate portion 52) in the vertical direction is longer than a length Z (FIG. 5) of the handle support stand 21 in the vertical direction (the handle support stand 21 is disposed on the pillar portion 3 to which the linking member 5 is fastened). In addition, the upper end of each portion of the linking member 5 is positioned above the upper end of the handle support stand 21, and the lower end of each portion of the linking member 5 is positioned below the lower end of the handle support stand 21.

In addition, as described above, the first fixed-plate portion 51 is fastened to the second plate portion 32 of the pillar portion 3 via the screws 54a to 54d, so that the linking member 5 is fixed to the pillar portion 3. The screws 54a to 54d are disposed, spaced from each other in the vertical direction. The screw 54a fastens the first fixed-plate portion 51 to the second plate portion 32 of the pillar portion 3 at a position above the upper end of the handle support stand 21. The screw 54b fastens the first fixed-plate portion 51 to the second plate portion 32 at a position within a range of the length Z of the handle support stand 21 in the vertical direction. Each of the screws 54c and 54d fastens the first fixed-plate portion 51 to the second plate portion 32 at a position below the lower end of the handle support stand 21.

In addition, the linking member 5 also includes connecting portions 55a and 55b that connect the intermediate plate portion 52 and the second fixed-plate portion 53 each other in a direction that intersects the vertical direction. The connecting portion 55a connects the intermediate plate portion 52 and the second fixed-plate portion 53 each other at a position above the upper end of the handle support stand 21, and the connecting portion 55b connects the intermediate plate portion 52 and the second fixed-plate portion 53 each other at a position below the lower end of the handle support stand 21. Note that the connecting portion may be disposed at only one of a position above the upper end of the handle support stand 21 and a position below the lower end of the handle support stand 21. Each of the connecting portions 55a and 55b as described above is a part of one plate portion of the intermediate plate portion 52 and the second fixed-plate portion 53. The part of the one plate portion is bent toward and fixed to another plate portion of the at least one intermediate plate portion 52 and the second fixed-plate portion 53.

Specifically, the connecting portion 55a is a brace portion that is formed perpendicular to the intermediate plate portion 52 and the second fixed-plate portion 53 at a position above the range of the length of the handle support stand 21 in the vertical direction, and that joins the intermediate plate portion 52 and the second fixed-plate portion 53 at the position. Similarly, the connecting portion 55b is a brace portion that is formed perpendicular to the intermediate plate portion 52 and the second fixed-plate portion 53 at a position below the range of the length of the handle support stand 21 in the vertical direction, and that joins the intermediate plate portion 52 and the second fixed-plate portion 53 at the position. In the present embodiment, each of the connecting portions 55a and 55b is formed by bending the second fixed-plate portion 53, and joining the bent portion and the intermediate plate portion 52 by crimping the bent portion onto the intermediate plate portion 52. In this manner, the connecting portions 55a and the 55b connect the second fixed-plate portion 53 and the intermediate plate portion 52. Note that the connecting portion and the plate portion may be joined with each other by using another method, such as a method using welding or screws, other than the crimping. In another case, each of the connecting portions 55a and 55b may be a separate portion different from the second fixed-plate portion 53 and the intermediate plate portion 52. In this case, the separate connecting portion may be joined with the second fixed-plate portion 53 and the intermediate plate portion 52 by using a joining method such as the crimping.

Note that as illustrated in FIG. 6, in the linking member 5 of the present embodiment, an edge portion of the first fixed-plate portion 51 opposite to the first bent portion 51R in the width direction of the first fixed-plate portion 51 is bent at a substantially right angle toward a direction opposite to the first plate portion 31 (see FIG. 4, for example). That is, the linking member 5 includes a plate portion 56 formed so as to extend from the edge portion of the first fixed-plate portion 51 opposite to the first bent portion 51R, toward a direction opposite to the first plate portion 31. The edge portion of the first fixed-plate portion 51 and an edge portion of the plate portion 56 are caused to be continuous with each other, by a bent portion 56R that is bent such that the edge line of the bent portion 56R extends along the vertical direction. This configuration increases the stiffness of the first fixed-plate portion 51. Note that the plate portion 56 and the bent portion 56R may not be formed.

Similarly, in the linking member 5, an edge portion of the second fixed-plate portion 53 opposite to the second bent portion 52R in the width direction of the second fixed-plate portion 53 is bent at a substantially right angle toward a direction opposite to the direction in which the intermediate plate portion 52 is formed so as to extend. That is, the linking member 5 includes a plate portion 57 formed so as to extend from the edge portion of the second fixed-plate portion 53 opposite to the second bent portion 52R, toward a direction opposite to the direction in which the intermediate plate portion 52 is formed so as to extend. The edge portion of the second fixed-plate portion 53 and an edge portion of the plate portion 57 are caused to be continuous with each other, by a bent portion 57R that is bent such that the edge line of the bent portion 57R extends along the vertical direction. This configuration increases the stiffness of the second fixed-plate portion 53. Note that the plate portion 57 and the bent portion 57R may not be formed.

As described above, the linking member 5 is a metal plate that includes a plurality of bent portions bent such that each edge line extends along the vertical direction. Specifically, the linking member 5 has a shape in which the first fixed-plate portion 51, the intermediate plate portion 52, and the second fixed-plate portion 53 are caused to be continuous with each other by the first bent portion 51R and the second bent portion 52R bent such that each edge line extends along the vertical direction. Thus, even if a certain point of the linking member 5 in the vertical direction serves as a fulcrum, and force is exerted on another point of the linking member 5 in the vertical direction, toward a direction orthogonal to the vertical direction, the linking member 5 hardly bends. In other words, the linking member 5 has high stiffness against the force exerted in a direction orthogonal to the vertical direction. Furthermore, since the linking member 5 includes the plate portions 56 and 57 and the bent portions 56R and 57R, the stiffness of the linking member 5 against the force exerted in a direction orthogonal to the vertical direction can be further increased.

As illustrated in FIG. 5, if the image forming apparatus 1 is lifted in a state where the handle portion 20 is held, the handle portion 20 is applied with force Fm necessary for lifting the image forming apparatus 1. In the present embodiment, the handle portion 20 is disposed in each of four positions in total: two positions in one side of the image forming apparatus 1 in the right and left direction and two positions in the other side of the image forming apparatus 1 in the right and left direction (that is, the handle portion 20 is disposed in each of both sides of the image forming apparatus 1). Thus, the force exerted on the handle portion 20 in one position when the image forming apparatus 1 is lifted is about ¼ of the weight of the image forming apparatus 1. On the pillar portion 3 on which the handle support stand 21, which supports the handle portion 20, is disposed, force Fm1 is exerted by the force Fm necessary for lifting the image forming apparatus 1. The force Fm1 is exerted, with the lower end (i.e., a point C in FIG. 5) of the handle support stand 21 serving as a fulcrum, on the upper end of the handle support stand 21 toward an S direction, in which the pillar portion 3 may be bent to the extent that the pillar portion 3 deforms elastically.

As described above, the upper end of each portion of the linking member 5 (i.e., each of the first fixed-plate portion 51, the second fixed-plate portion 53, the first and second bent portions 51R and 52R, and the intermediate plate portion 52) is positioned above the upper end of the handle support stand 21, and the lower end of each portion of the linking member 5 is positioned below the lower end of the handle support stand 21. Thus, the range in which each portion of the linking member 5 is included in the vertical direction includes a fulcrum (i.e., the point C), which is the lower end of the handle support stand 21, and a point of application (i.e., a position on which the force Fm1 is exerted) which is the upper end of the handle support stand 21.

In the present embodiment, the upper end of each of the first fixed-plate portion 51, the second fixed-plate portion 53, the first and second bent portions 51R and 52R, and the intermediate plate portion 52 is positioned above the upper end of the handle support stand 21, and the lower end of each of the first fixed-plate portion 51, the second fixed-plate portion 53, the first and second bent portions 51R and 52R, and the intermediate plate portion 52 is positioned below the lower end of the handle support stand 21. Since the linking member 5 having such a configuration is fixed to the pillar portion 3, the stiffness of a portion of the pillar portion 3, on which portion the force Fm1 is exerted, is further increased. That is, at least part of the force Fm1 can be received by the linking member 5. In other words, the range in which force is exerted by the force Fm1 (i.e., the range in which stress is produced by the force Fm1) is set to a range to which the linking member 5 is fixed. Note that the configuration in which the handle support stand 21 is disposed between the upper end and the lower end of each plate portion produces higher stiffness. Even if the handle support stand 21 and the linking member 5 are disposed at positions different from each other in the vertical direction, the stiffness can be increased by the linking member 5 that includes the at least two bent portions.

In addition, in the present embodiment, the range in which the force Fm1 is exerted in the range of the linking member 5 is a range of the second fixed-plate portion 53 of the linking member 5 that extends from the second bent portion 52R by up to about 20 mm. Thus, as described above, the predetermined fastening position 53T, at which the board supporting member 61 is fastened to the second fixed-plate portion 53 of the linking member 5, is separated from the second bent portion 52R. Specifically, the predetermined fastening position 53T is a position which is separated from the second bent portion 52R by about 20 mm or more, and at which the force Fm1 is not exerted. Thus, in a case where the circuit board 62 is disposed in the vicinity of the pillar portion 3 on which the handle portion 20 is disposed, the external force is not exerted on the circuit board 62 because the linking member 5 of the present embodiment is disposed.

Note that the predetermined fastening position 53T may be a position separated from the second bent portion 52R by less than about 20 mm as long as the distance d1 between the predetermined fastening position 53T and the edge portion of the second fixed-plate portion 53 opposite to the second bent portion 52R (i.e., the edge portion of the second fixed-plate portion 53 on the right side in FIG. 5) is shorter than the distance d2 between the predetermined fastening position 53T and the second bent portion 52R (d1<d2). Even in this case, since the force exerted on the predetermined fastening position 53T by the force Fm1 is made smaller than the force in a case where the distance d1 is longer than the distance d2, the external force exerted on the circuit board 62 can be suppressed.

In addition, in the linking member 5 of the present embodiment, the intermediate plate portion 52 and the second fixed-plate portion 53 are connected to each other via the connecting portions 55a and 55b. Thus, it is possible to increase the stiffness of a portion constituted by the first fixed-plate portion 51 and the first bent portion 51R, the intermediate plate portion 52, and a portion constituted by the second fixed-plate portion 53 and the second bent portion 52R. That is, since the external force exerted by the force Fm1 is dispersed by the portion constituted by the first fixed-plate portion 51 and the first bent portion 51R, the intermediate plate portion 52, and the portion constituted by the second fixed-plate portion 53 and the second bent portion 52R, it is possible to prevent the external force from concentrating on the first fixed-plate portion 51 and the first bent portion 51R of the linking member 5. In this manner, the stiffness of a portion of the pillar portion 3 (to which the linking member 5 is fixed), on which portion the force Fm1 is exerted, can be further increased.

Note that the connecting portions 55a and 55b, which connect the intermediate plate portion 52 and the second fixed-plate portion 53, also ensure the stiffness against the force exerted in work for fastening the board supporting member 61, used for the circuit board 62, to the second fixed-plate portion 53 of the linking member 5 via the screw 64. For example, since the connecting portions 55a and 55b are disposed, it is possible to suppress the second fixed-plate portion 53 from bending toward a direction in which the second fixed-plate portion 53 moves (i.e., a direction in which the second fixed-plate portion 53 is pressed by a screwdriver or the like) when the screw 64 is pressed against the second fixed-plate portion 53 with a screwdriver or the like in the fastening work.

Thus, in the present embodiment, itis possible to suppress the external force from being exerted on the circuit board 62 even if the handle portion 20 is fixed to the pillar portion 3, in the vicinity of which the circuit board 62 is disposed. As a result, the flexibility in layout of the circuit board 62 in the casing 4 increases, and the image forming apparatus 1 can be made compact.

### OTHER EMBODIMENTS

In the above-described embodiment, the description has been made for the case where the present invention is applied to the configuration in which an electrophotographic image forming apparatus is used as the image forming apparatus. However, the present invention can also be applied to another-type image forming apparatus, such as an ink-jet image forming apparatus.

In addition, in the above-described embodiment, the description has been made for the configuration in which the linking member 5 includes the single intermediate plate portion 52, the first bent portion 51R, and the second bent portion 52R. However, two or more intermediate plate portions and three or more bent portions may be formed in the linking member 5. For example, the linking member may include a first intermediate plate portion, a second intermediate plate portion, and a third bent portion that connects the first intermediate plate portion and the second intermediate plate portion. In addition, an angle at which a bent portion is bent, that is, an angle formed by a pair of plate portions, which are caused to be continuous with each other by the bent portion, is preferably a right angle. However, the angle may be an obtuse angle or an acute angle. In addition, angles at which the plurality of bent portions are bent may be different from each other.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-077478, filed May 10, 2024 which is hereby incorporated by reference herein in its entirety.

What is claimed is:

1. An image forming apparatus configured to form an image on a recording material, the image forming apparatus comprising:
a casing including a pillar portion extending in a vertical direction;
a circuit board;
a board supporting member configured to support the circuit board;
a base fixed to the pillar portion;
a handle portion supported by the base; and
a linking member formed of a bent plate member and configured to link the pillar portion and the board supporting member,
wherein the linking member includes
a first fixed-plate portion fixed to the pillar portion,
a second fixed-plate portion to which the board supporting member is fixed,
a first bent portion formed at an edge portion of the first fixed-plate portion,
a second bent portion formed at an edge portion of the second fixed-plate portion, and
at least one intermediate plate portion configured to connect the first bent portion and the second bent portion continuously, and
wherein each of the first bent portion and the second bent portion is bent such that an edge line extends along the vertical direction.

2. The image forming apparatus according to claim 1, wherein each of the first fixed-plate portion, the second fixed-plate portion, the first bent portion, the second bent portion, and the at least one intermediate plate portion is formed so as to extend in the vertical direction such that an upper end of each of the first fixed-plate portion, the second fixed-plate portion, the first bent portion, the second bent portion, and the at least one intermediate plate portion is positioned above an upper end of the base, and that a lower end of each of the first fixed-plate portion, the second fixed-plate portion, the first bent portion, the second bent portion, and the at least one intermediate plate portion is positioned below a lower end of the base.

3. The image forming apparatus according to claim 1, wherein the pillar portion is formed by a bent plate member made of metal and includes
a first plate portion to which the base is fixed,
a second plate portion formed so as to extend from the first plate portion toward the circuit board side, and
a pillar-side bent portion bent such that the pillar-side bent portion connects the first plate portion and the second plate portion continuously, and that an edge line of the pillar-side bent portion extends along the vertical direction, and
wherein the first fixed-plate portion is fixed to the second plate portion.

4. The image forming apparatus according to claim 1, wherein the at least one intermediate plate portion includes a first intermediate plate portion,
wherein the first bent portion connect the first fixed-plate portion and the first intermediate plate portion continuously, and
wherein the second bent portion connect the first intermediate plate portion and the second fixed-plate portion continuously.

5. The image forming apparatus according to claim 1, wherein the at least one intermediate plate portion includes a first intermediate plate portion and a second intermediate plate portion, and
wherein the linking member further includes a third bent portion configured to connect the first intermediate plate portion and the second intermediate plate portion continuously.

6. The image forming apparatus according to claim 1, further comprising:
a board-side fastening member configured to fasten the board supporting member to the second fixed-plate portion at a predetermined fastening position, and
wherein a distance between the predetermined fastening position and an edge portion of the second fixed-plate portion opposite to the second bent portion is shorter than a distance between the predetermined fastening position and the second bent portion.

7. The image forming apparatus according to claim 1, wherein the linking member includes a connecting portion extending in a direction that intersects the vertical direction, and configured to connect the at least one intermediate plate portion and the second fixed-plate portion.

8. The image forming apparatus according to claim 7, wherein the connecting portion is configured to connect the at least one intermediate plate portion and the second fixed-plate portion at a position above an upper end of the base, a position below a lower end of the base, or the position above the upper end of the base and the position below the lower end of the base.

9. The image forming apparatus according to claim 7, wherein the connecting portion is a part of one plate portion of the at least one intermediate plate portion and the second fixed-plate portion,
wherein the part of the one plate portion is bent toward and fixed to another plate portion of the at least one intermediate plate portion and the second fixed-plate portion.

10. The image forming apparatus according to claim 1, further comprising:
a pivot shaft disposed such that its axis extends in a direction intersecting the vertical direction, and configured to support a base end portion of the handle portion such that the handle portion is able to pivot with respect to the base,
wherein the handle portion is configured to pivot between a first position and a second position around the pivot shaft, the second position being a position at which a tip portion of the handle portion is separated more from the pillar portion than the tip portion of the handle portion positioned in the first position is, and
wherein the base includes a regulation portion configured to prevent the handle portion from further pivoting, in a state where the handle portion is positioned in the second position, toward a pivot direction in which the handle portion pivots on the pivot shaft from the first position toward the second position.
